(19) United States
(12) Patent Application Publication
(10) Pub. No.: US 2007/0011710 A1
(43) Pub. Date: Jan. 11, 2007

(54) Interactive news gathering and media production control system

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,858

(22) Filed: Jul. 5, 2005

(51) Int. Cl. H04N 7/173

(52) U.S. Cl. 725/95; 725/117; 725/116

(57) ABSTRACT

A media production control system with built-in newsgathering and fact-checking tools, able to receive news feeds in multiple formats from many sources, and featuring geographic portability and low cost. The system allows a producer to select and queue individual feeds for broadcast or limited distribution, using either the system's software or an externally coupled device. Shared communications tools comprise a web browser, an instant-messaging package, a chat room, a headlines display, and a virtual whiteboard.

### BACKGROUND OF THE INVENTION

1. Field of the Invention

The present invention relates to a media production control system. More specifically, the present invention discloses an interactive news gathering and media production system able to accept a large number of feeds in multiple formats, featuring a conferencing system and a shared web browser and whiteboard.

2. Description of the Prior Art

Traditionally, television news production required an expensive newsroom facility filled with equipment in order to support a news anchor, typically reading the stories off a teleprompter. The expense and complexity soared when using a remote reporter to provide a live feed of an event via satellite news gathering (SNG); the remote reporter had to transmit the report back to the newsroom facility using a radio-frequency link, often via satellite. Even a live remote feed unit for local coverage required an expensive van with a powerful transmitter.

However, the production facility, remote feed units, and trained crews were extremely expensive, limiting the ability to produce television news to corporations able to make large investments in infrastructure. The expense and complexity also limited the number of remote feeds that could be supported; with only a few remote feed units, news producers had to allocate these scarce resources carefully, missing some newsworthy events and being unable to completely cover widespread events. Merely adding more remote feed units would not be practical, as the production systems were set up for a small number of remotes.

Therefore there is need for a media production control system which uses common inexpensive equipment in multiple formats for remote units, gives producers an easy way to manage a large number of remote units, and is easy to use.

### SUMMARY OF THE INVENTION

To achieve these and other advantages and in order to overcome the disadvantages of the conventional method in accordance with the purpose of the invention as embodied and broadly described herein, the present invention provides a media production control system with several collaboration tools to facilitate communication among the producer and the remote units.

The present invention further provides a media production control system that can be linked to a variety of different kinds of remote units, thus facilitating the use of inexpensive new technologies while still allowing the use of expensive prior-art equipment. This has the added benefit of driving down the barriers to entry, allowing small groups to produce news independent of major media organizations.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings, FIG. 1 is a block diagram showing a news production system according to an embodiment of the present invention;

FIG. 2 is a block diagram illustrating a control panel of an embodiment of the present invention;

FIG. 3 is a block diagram of a second software display panel of an embodiment of the present invention;

FIG. 4 is a block diagram showing a meeting facilitation system according to an embodiment of the present invention; and

FIG. 5 is a block diagram of a client remote system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Please refer to FIG. 1, which shows a block diagram of a news production system according to an embodiment of the present invention. The system 100 accepts multiple news feeds from sources 101˜105, which are coupled across a network 110 to the core server 120 and stream server 130, optionally encrypting the packets of the feeds using VPN (virtual private network) technology for security. The network 1 10 is an internet or intranet, and data can flow over it via either TCP/IP or UDP/IP. The core server 120 is coupled to an audio control console 150 and a video control console 160, which provide switching, fading, volume, and color adjustment capabilities for the signals. It should be noted that the audio control console 150 and video control console 160 are optional hardware equipment; the capabilities that these provide are also implemented in software. The ability to accept input from these hardware devices is for providing convenience and familiar interfaces to the user. The system produces an output 200 which is typically broadcast, webcast, and/or saved for later use.

The sources 101˜105 comprise various types of input feeds. A feed can be audio-only, audio-video, video-only, or textual. For example, an audio feed may be a radio transmission, a phone call via wired phone, cellphone, or voice-over-IP (VoIP) phone, or a microphone coupled by a wired or wireless connection; an audio-video feed may be a webcam sending digital audio-video over IP, or a professional news camera transmitting an analog audio-video signal via electromagnetic waves, even via satellite 180 to a base station 185; a video-only feed may be a webcam sending a digital video-only stream over IP; or a textual feed may be a headline list being sent by SGML, XML, RSS, HTML, or other text-based computer format.

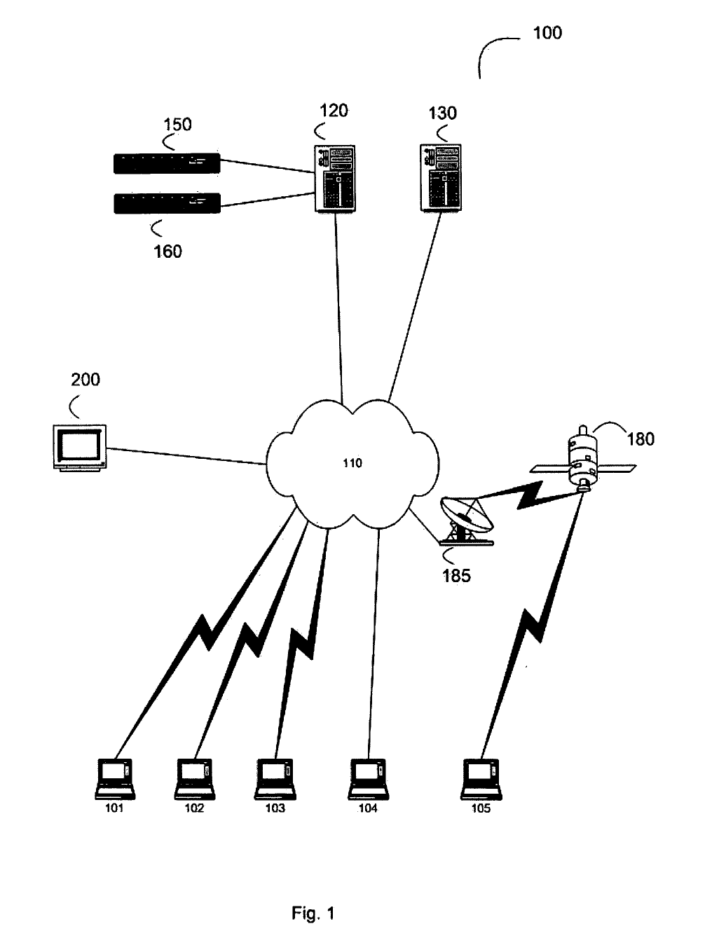

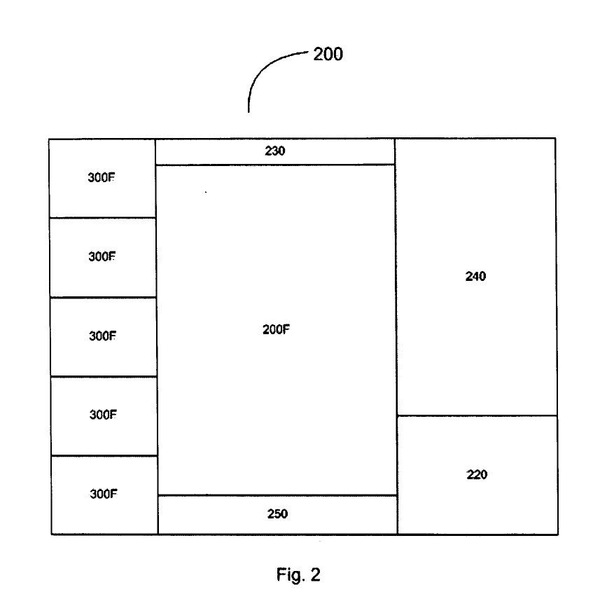

Please refer to FIG. 1 in combination with FIG. 2, which shows a block diagram of one software display panel 200 of an embodiment of the present invention. The producer has the ability to select a feed from the input feeds 101F˜105F from the sources 101105 respectively, where the producer can then use the control panel 250 to perform some operation on the selected feed, such as making it the output feed 200F or recording it using the digital video recording (DVR) tool. The DVR tool also has a metadata editor, which lets identifying data be added to the recorded audio-video data. The identifying data comprises time and date, reporter name, location, content description, or any other information desired. A tool selection control panel 230 allows the producer to choose which collaboration tool to use from the available shared tools, which comprise a whiteboard, a web browser, a chat room, a news bulletin board, and an instant-messaging tool 240 (currently in use). Connections are bi-directional, so the producer or anchor can also talk to the reporter providing the feed. The producer can also send files to one, several, or all sources, for example to distribute the day's initial assignments. Applications can be shared via VNC (virtual network computing) as well, so that sources with less-powerful equipment can use computing-intensive applications or to reduce system administration overhead. These tools are viewable by the sources 101˜105 on their client software so that the sources 101˜105 are informed of the current focus of attention, whether this is fact-checking or gathering background information on the web with the shared browser, discussing a developing story (or just chatting to develop team spirit during a break) in the chatroom, diagramming or planning using the whiteboard, checking breaking news on the news bulletin board (perhaps for the purpose of going to a new location to catch a story), or sending short comments via instant messenger. The sources 101˜105 are also able to signal the producer when they have a breaking news flash by using the instant messenger tool. The producer also has the ability to arrange polls so that sources can have a say in which story is being run with the messenger control panel 220. Note that although five feeds are shown, the split-screen view is customisable for a variable number of feeds in a grid, for example, a 3-by-3 grid of feeds can be shown instead of the 5-by-1 view of the figure. Additionally, if the configured view is too small to show the full number of feeds, a scrollbar (not shown) appears to allow the producer to scroll through the available feeds.

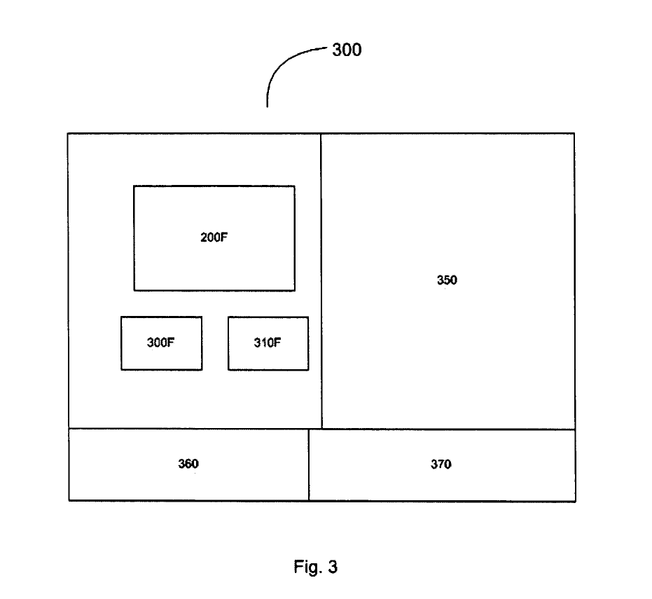

Please refer to FIG. 1 in combination with FIG. 3, which shows a diagram of a second software display panel 300 of an embodiment of the present invention. In this view, the producer can watch the current output feed 200F while also watching a second feed 300F and a third feed 310F, to keep an eye on the feeds which will be used as the current output feed 200F as the program switches segments or as they switch from the in-station anchor to a remote reporter. The feeds and switching provide low latency of less than 1.5 seconds. A teleprompter tool 350 is available in another panel, as are a chat room tool 360 and a news bulletin board tool 370.

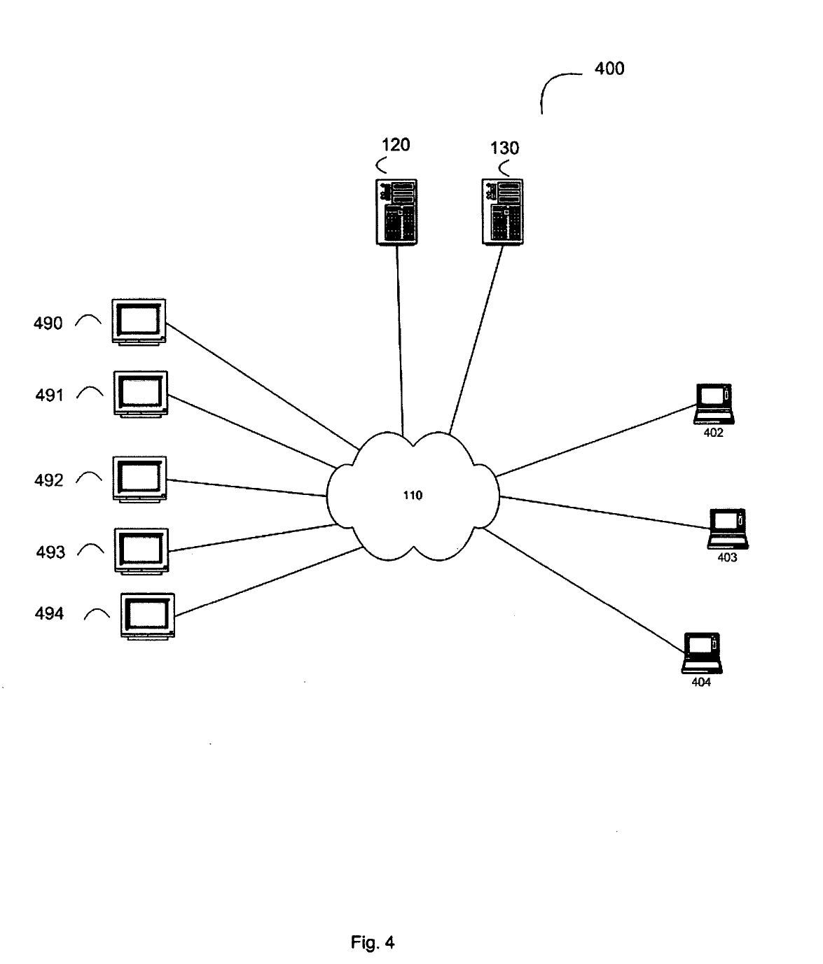

Please refer to FIG. 4, which shows a block diagram of a conferencing system according to an embodiment of the present invention. The conferencing system 400 accepts multiple news feeds from sources 400˜402 such as conference presenters, which are coupled across a network 110 to the core server 120 and stream server 130, optionally encrypting the packets of the feeds using VPN technology for security. The system produces an output 450 which is webcast to conference attendees 490˜494. In this use, the collaboration tools can be used for asking questions of the conference presenters by the attendees, or for displaying lecture notes, formulae, and other information from the conference presenters to the attendees. The system is well-suited for business conferences, scientific symposia, remote education, interactive game shows, and myriad other uses. The output can be recorded for subsequent distribution. Conference attendees 490-494 can be connected bidirectionally, so that they may participate in the conference, or unidirectionally, so that they can only view the presentations. Conference attendees 490˜494 may be connected bidirectionally with a full client package providing them with the ability to create an audio-video data feed to the conference, equal to that of conference presenters, or they may use a limited package which only provides the collaborative tools so that they may communicate via chatroom and shared browser.

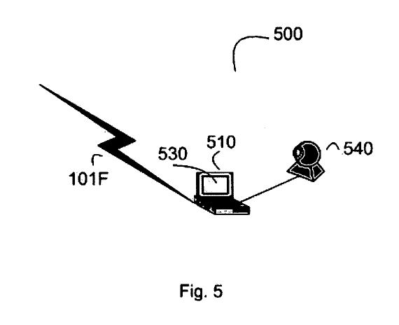

Please refer to FIG. 5, an illustration of a client package able to act as a feed in the present invention system. The client package 500 comprises a notebook computer 510 with wireless networking card 520 running client software 530. A webcam 540 and headset 550 (the headset 550 comprising an earphone 552 and microphone 554) provide the video and audio portions of the news feed 101F. The client package 500 is readily portable and can send a news feed 101F from any location where the wireless networking card 520 can connect to an existing wireless network, ranging from a large network such as the city-wide WiFly™ system presently being installed in Taipei, Taiwan, to a cellular DSL network, down to a small home wireless network that the owner has opened to the reporter's use. A wired broadband network or even modem networking can be substituted if wireless networking is unavailable. While this package is typical, a reporter can call in via a phone (cellular, VoIP, or land line) to provide a voice-only feed (or even an audio-video feed, with a video cellphone) or use a full-scale satellite van as is presently used by the news media; the system is not restricted to any particular source for a news feed, rather it provides additional previously-unavailable options. The system software can use a reduced audio or video quality over a slower network; for example, using G723 audio at 24 Kbits per second instead of PCM audio at 176 Kbits per second, or using a video frame rate as low as one frame per second over a modem connection instead of the more typical thirty frames per second on a fast network. Bandwidth detection and feed rate quality are handled automatically. Audio and video can be handled in multiple formats and codecs.

This news production control system thus provides a dramatic improvement over the limited and expensive prior art. Hordes of individuals armed with little more than a notebook computer, webcam, and wireless networking card can send news feeds to a news producer for redistribution, allowing for news gathering from many more locations and for far more diversity in the news.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A media production control system comprising:
a plurality of input sources coupled to a network for creating feed data, the network capable of transferring data;
a plurality of servers coupled to the network for processing feed data, comprising at least a core server for managing the feed data from the input sources, and a streaming server for creating an output data stream;
a server software program for managing the input sources and for producing an output; and
a client software program for communicating with the server software program.

2. The media production control system of claim 1 further comprising an external video control console coupled to the core server.

3. The media production control system of claim 1 further comprising an external audio control console coupled to the core server.

4. The media production control system of claim 1 where the server software program further comprises:
a media content encoder operating in near-real-time for encoding media content;
a multipanelled user interface for selecting an active input source from the plurality of input sources; and
a plurality of collaborative programs for communicating with the plurality of input sources.

5. The media production control system of claim 4 where the collaborative programs comprise a chat room, a shared web browser, a streaming text data feed, an instant-messaging package, and a whiteboard.

6. The media production control system of claim 1 further comprising a plurality of client packages, each client package comprising:
a computer;
a camera unit coupled to the computer for producing video input data;
a headset, comprising a microphone and earphone, coupled to the computer for communicating with an operator and for producing audio input data,
the client software program; and
a networking device for connecting to the network.

7. The media production control system of claim 6, where the networking device is selected from the group consisting of a modem, an Ethernet port, an IEEE 802.11(b) wireless networking device, an 802.11(g) wireless networking device, and an 802.11(h) wireless networking device.

8. The media production control system of claim 6, the client software program comprising:
a source creation subsystem for producing an input source from the audio input data and the video input data;
a user interface for interacting with the collaborative programs of the server software program; and
a networking program for coupling to the network and for detecting a bandwidth of the network.

9. The media production control system of claim 8 where the source creation subsystem adjusts the input source according to the bandwidth of the network.

10. The media production control system of claim 1 further comprising a digital audio-video recorder for recording a subset of the plurality of input data.

11. The media production control system of claim 10 further comprising a recording software program for controlling the digital audio video recorder.

12. The media production control system of claim 11 further comprising a metadata editing program for annotating a recorded audio-video input data.

13. The media production system of claim 1 where each input source of the plurality of input sources is selected from the group consisting of a land-line telephone, a cellular telephone, a satellite cellular telephone, a radio transceiver, a remote news video system, a satellite news video system, and the client package.

14. The media production control system of claim 1 further comprising a plurality of limited packages, each limited package comprising:
a computer;
a client software program comprising a user interface for interacting with the collaborative programs of the server software program; and
a networking device for connecting to the network.

15. The media production control system of claim 14 where the networking device is selected from the group consisting of a modem, an Ethernet port, an IEEE 802.11(b) wireless networking device, an 802.11(g) wireless networking device, and an 802.11(h) wireless networking device.

16. A media production control system with a client system, the client system, comprising:
a computer;
a camera unit coupled to the computer for producing video input data;
a headset, comprising a microphone and earphone, coupled to the computer for communicating with an operator and for producing audio input data;
a client software program; and
a networking device for connecting to a network.

17. The media production system of claim 16, the client software program comprising:
a source creation subsystem for producing an input source from the audio input data and the video input data;
a user interface for interacting with collaborative programs of a server software program; and
a networking program for coupling to the network and for detecting a bandwidth of the network.

18. The media production system of claim 16 where the networking device is selected from the group consisting of a modem, an Ethernet port, an IEEE 802.11(b) wireless networking device, an 802.11(g) wireless networking device, and an 802.11(h) wireless networking device.

19. The media production system of claim 16 where the source creation subsystem adjusts the input source according to the bandwidth of the network.
